(19) United States
(12) Patent Application Publication
(10) Pub. No.: US 2004/0160156 A1
(43) Pub. Date: Aug. 19, 2004

(54) Electrode for a battery and production method thereof

(75) Inventors: Tsumoru Ohata, Kyoto-shi (JP); Masao Fukunaga, Osaka (JP)

Correspondence Address: MCDERMOTT, WILL & EMERY, 600 13th Street, N.W., WASHINGTON, DC, 20005-3096, US

(73) Assignee: MATSUSHITA ELECTRIC INDUSTRIAL CO., LTD.

(21) Appl. No.: 10/769,866

(22) Filed: Feb. 3, 2004

(30) Foreign Application Priority Data
Feb. 19, 2003 (JP) JP2003-041285

(51) Int. Cl. H01K 1/04; H01J 1/14; H01J 19/06

(52) U.S. Cl. 313/346 R

(57) ABSTRACT

An electrode for a battery superior in conductivity with small amount of conductive material, yet with high capacity is provided by a method comprising the steps of: (a) producing a masterbatch comprising at least carbon nanotubes and a resin; (b) blending an electrode material mixture containing at least the masterbatch and an electrode active material with a dispersion medium to prepare an electrode material mixture paste; (c) applying the electrode material mixture paste onto an electrode substrate and then drying and rolling the electrode material mixture paste coated on the electrode substrate to obtain an electrode plate; and (d) cutting the electrode plate to obtain an electrode with a predetermined shape.

### BACKGROUND OF THE INVENTION

In recent years, information electronic devices such as a personal computer, a cell phone and a PDA and audio-visual electronic devices such as a video camcorder and a mini disk player have rapidly been made smaller and lighter and made cordless. With this development, demand is increasing for secondary batteries with higher energy density for use as power sources in these electronic devices. Under such circumstances, the commercialization of non-aqueous electrolyte secondary batteries having high energy density that has not been attained by conventional secondary batteries such as a lead-acid storage battery, a nickel-cadmium storage battery and a nickel-metal hydride storage battery is proceeding.

An electrode of non-aqueous electrolyte secondary batteries as typified by a lithium ion secondary battery and a lithium ion polymer secondary battery is typically produced by mixing an electrode active material with a conductive material and a binder to form a paste, which is then applied onto a current collector made of aluminum, titanium, stainless steel or the like, followed by rolling. A conductive material is used to secure the conductivity of an electrode. If the amount of conductive material is large, however, the battery capacity will be decreased. Accordingly, in order to reduce the amount of conductive material to be used, it is proposed to use a masterbatch process, whereby a conductive material is uniformly predispersed in a binder, in the production of a positive electrode (see Japanese Laid-Open Patent No. Hei 10-255844). As a conductive material, carbon black such as furnace black or acetylene black, and powdered graphite are used.

The primary particles of carbon black or powdered graphite are linked into a chain to form a conductive path. Such conductive path is likely to be damaged by shearing force. Shearing force is applied to the conductive material during the masterbatch process. For this reason, the use of the masterbatch process to uniformly disperse the conductive material in a binder does not yield an electrode superior in conductivity.

### BRIEF SUMMARY OF THE INVENTION

In view of this, it is an object of the present invention to provide an electrode superior in conductivity with a small amount of conductive material, yet with high capacity.

The present invention relates to a method for producing an electrode for a battery comprising the steps of: (a) producing a masterbatch comprising at least carbon nanotubes and a resin; (b) blending an electrode material mixture containing at least the masterbatch and an electrode active material with a dispersion medium to prepare an electrode material mixture paste; (c) applying the electrode material mixture paste onto an electrode substrate and then drying and rolling the electrode material mixture paste coated on the electrode substrate to obtain an electrode plate; and (d) cutting the electrode plate to obtain an electrode with a predetermined shape. In the step (b), in addition to the masterbatch and the electrode active material, the resin and/or a second resin can be blended with the dispersion medium.

The carbon nanotubes preferably have an average diameter (outer diameter) of not greater than 0.1 μm and an aspect ratio of not less than 100 determined by dividing the average length of the carbon nanotubes by the average diameter. The proper amount of the carbon nanotubes contained in the masterbatch is 5 to 20 parts by weight per 100 parts by weight of the resin.

In the case where the electrode active material is a positive electrode active material, the substrate comprises aluminum or an aluminum alloy, and the amount of the carbon nanotubes contained in the electrode material mixture is, for example, 0.2 to 3 parts by weight per 100 parts by weight of the electrode active material.

In the case where the electrode active material is a negative electrode active material, the substrate comprises copper, a copper alloy, nickel, a nickel alloy, iron or an iron alloy; and the amount of the carbon nanotubes contained in the electrode material mixture is, for example, 0.2 to 3 parts by weight per 100 parts by weight of the electrode active material.

The present invention further relates to a positive electrode comprising a positive electrode active material, a resin and carbon nanotubes, wherein the carbon nanotubes have an average diameter of not greater than 0.1 μm and an aspect ratio of not less than 100 determined by dividing the average length of the carbon nanotubes by the average diameter, and the amount of the carbon nanotubes is 0.2 to 3 parts by weight per 100 parts by weight of the positive electrode active material.

The present invention still further relates to a negative electrode comprising a negative electrode active material, a resin and carbon nanotubes, wherein the carbon nanotubes have an average diameter of not greater than 0.1 μm and an aspect ratio of not less than 100 determined by dividing the average length of the carbon nanotubes by the average diameter, and the amount of the carbon nanotubes is 0.2 to 3 parts by weight per 100 parts by weight of the negative electrode active material.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1(a) is a schematic diagram showing that carbon nanotubes are tangled and twisted with one another before they are blended with a resin.

FIG. 1(b) is a schematic diagram showing that the carbon nanotubes are unraveled and straightened after they have been blended with a resin.

FIG. 2 is a partially cutaway oblique view of a non-aqueous electrolyte secondary battery of the present invention.

### DETAILED DESCRIPTION OF THE INVENTION

A method for producing an electrode for a battery of the present invention has a step of producing a masterbatch by blending at least carbon nanotubes with a resin. Unlike carbon black and powdered graphite, a conductive path to be formed by carbon nanotubes is not damaged by shearing force. Accordingly, even if high sharing force is applied to the carbon nanotubes during the preparation of a masterbatch, it is possible to obtain an electrode superior in conductivity.

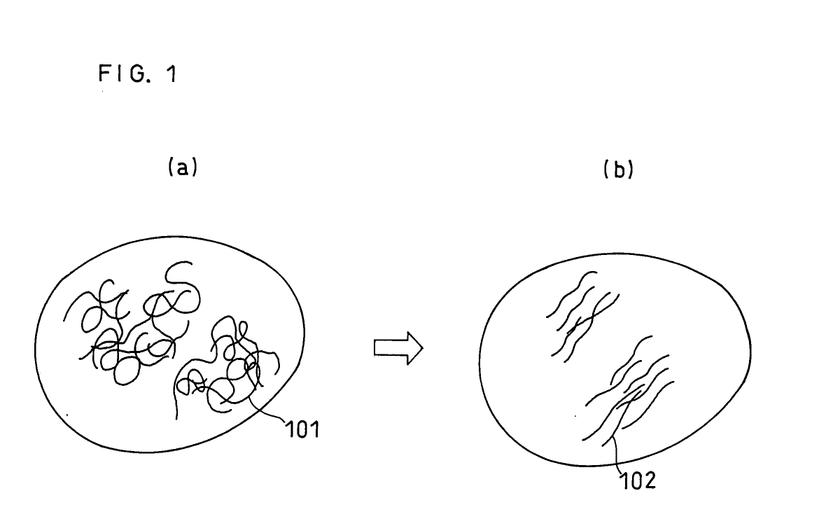

As shown in FIG. 1(a), carbon nanotubes 101 are tangled and twisted with one another before they are blended with a resin. The carbon nanotubes are unraveled and straightened by blending them with a resin, as shown in FIG. 1(b). The unraveled and straightened carbon nanotubes 102 are expected to form an excellent conductive path in an electrode even if the amount thereof is small.

The resin with the unraveled and straightened carbon nanotubes dispersed therein also serves to increase the mechanical strength of an electrode plate. The electrode plate comprising such carbon nanotubes has a great strength against bending and therefore electrode damage is unlikely to occur during the production of an electrode group. In addition, even when the electrode material mixture layer repeatedly expands and contracts during charging and discharging, the electrode is unlikely to be degraded and thus it is possible to produce a secondary battery excellent in cycle characteristics.

The carbon nanotubes preferably have a diameter of not greater than 0.1 μm. When the diameter of the carbon nanotubes is too large, uniform conductive paths may not be formed in some electrodes with a small amount of the carbon nanotubes. No problem arises when the diameter of the carbon nanotubes is small, however, it is difficult to produce carbon nanotubes with too small diameter. A carbon nanotube may contain one or more carbon nanotubes with a smaller diameter in the hollow thereof.

The carbon nanotubes preferably have an average length of 1 to 100 μm. When the carbon nanotubes are too short, excellent conductive paths may not be formed in some electrodes. No problem arises when the length of the carbon nanotubes is large; however, the dispersibility of the carbon nanotubes in the resin may be slightly low.

The carbon nanotubes preferably have an aspect ratio determined by dividing the average length of the carbon nanotubes by the average diameter of the same of not less than 100. When the aspect ratio is too small, excellent conductive paths may not be formed in some electrodes. Conversely, when the aspect ratio is too large, the carbon nanotubes are unlikely to be straightened sufficiently even after a resin is blended thereto. Accordingly, the aspect ratio is preferably not greater than 1000.

Although it is possible to add a resin during the step of preparing an electrode material mixture paste, the addition of the carbon nanotubes is difficult, taking the dispersibility of the carbon nanotubes in the resin into consideration. Therefore, the weight ratio of the carbon nanotubes to the resin contained in the masterbatch is preferably the same as or more than that of the carbon nanotubes to the resin contained in the electrode material mixture. The proper amount of the carbon nanotubes contained in the masterbatch is 5 to 20 parts by weight per 100 parts by weight of the resin.

As the resin in which the carbon nanotubes are dispersed, a fluorocarbon resin can be used. The fluorocarbon resin is preferably at least one selected from the group consisting of polyvinylidene fluoride and a vinylidene fluoride-hexafluoropropylene copolymer. They may be used singly or in combination of two or more.

An electrode material mixture paste can be prepared by blending an electrode material mixture containing the masterbatch and an electrode active material with a dispersion medium. During this process, a resin can be added to the electrode material mixture. The resin to be added may be the same resin as or a resin analogous to the one used during the production of the masterbatch, or a resin other than the above. In order to obtain a high-capacity electrode, the resin to be added is preferably particulate rubber that enables spot bonding between the active material particles.

The amount of the carbon nanotubes contained in the electrode material mixture is, for example, 0.2 to 3 parts by weight per 100 parts by weight of the electrode active material. In order to obtain a high-capacity electrode, the amount thereof is preferably not greater than 0.8 parts by weight. The dispersion medium should be selected according to the resin to be used. When polyvinylidene fluoride or a vinylidene fluoride-hexafluoropropylene copolymer is used, for example, N-methyl-2-pyrrolidone can be used.

An electrode plate can be obtained by applying the obtained electrode material mixture paste onto an electrode substrate, which is then dried and rolled. The electrode plate thus produced is cut into a predetermined shape to give an electrode intended. The positive electrode substrate may comprise, for example, aluminum or an aluminum alloy, and the negative electrode substrate may comprise, for example, copper, a copper alloy, nickel, a nickel alloy, iron or an iron alloy.

The positive electrode active material to be used varies depending on the battery type. As the positive electrode active material for a lithium secondary battery, there can be used, for example, a transition metal oxide such as lithium cobalt oxide (LiCoO₂), lithium nickel oxide (LiNiO₂) or lithium manganese oxide (LiMn₂O₄), or a solid solution material incorporating a plurality of transition metals such as LiCoₓNi_{y}Mn_{z}O₂ or Li (CoₐNi_{b}Mn_{c}) 204. They may be used singly or in combination of two or more.

The negative electrode active material to be used also varies depending on the battery type. As the negative electrode active material for a lithium secondary battery, there can be used, for example, a graphite material such as artificial graphite or natural graphite, graphitized mesophase carbon made from coal or petroleum pitch, or other carbonaceous materials such as hard carbon. An alloy material such as an Si—Ni alloy or an Sn—Ni alloy can also be used as the negative electrode active material. They may be used singly or in combination of two or more.

In the following, the present invention is specifically described based on Examples.

### EXAMPLE 1

(i) Production of Positive Electrode

Fifteen parts by weight of carbon nanotubes and 85 parts by weight of polyvinylidene fluoride as a resin component were blended in an extruder to produce a masterbatch. The residence time in the extruder was 5 minutes. The masterbatch was formed into cylindrical pellets with a diameter of 0.3 mm and a length of 0.3 mm. The carbon nanotubes used here had an average diameter of 0.05 μm and an aspect ratio of 100.

It is to be noted that the average diameter of the carbon nanotubes and the average length thereof were determined from the actual values obtained by observing 100 carbon nanotubes by TEM (transmission electron microscope). The aspect ratio was determined by dividing the average length by the average diameter.

A positive electrode material mixture paste was prepared by mixing 3.3 parts by weight of the resultant masterbatch, 100 parts by weight of lithium cobalt oxide (LiCoO₂) as an active material and 45 parts by weight of N-methyl-2-pyrrolidone with a mixer. The masterbatch was easily dissolved in N-metyl-2-pyrrolidone (60° C.). This positive electrode material mixture paste was applied onto both faces of a 20-μm-thick substrate made of aluminum foil, which was then dried and rolled. The electrode plate thus obtained was cut into a predetermined shape to give a positive electrode.

(ii) Production of Negative Electrode

A negative electrode material mixture paste was prepared by mixing 100 parts by weight of flake graphite as an active material, 3 parts by weight of styrene butadiene rubber as a binder and 54 parts by weight of water with a mixer. The negative electrode material mixture paste was applied onto both faces of a 10-μm-thick substrate made of copper foil, which was then dried and rolled. The electrode plate thus obtained was cut into a predetermined shape to give a negative electrode.

(iii) Production of Battery

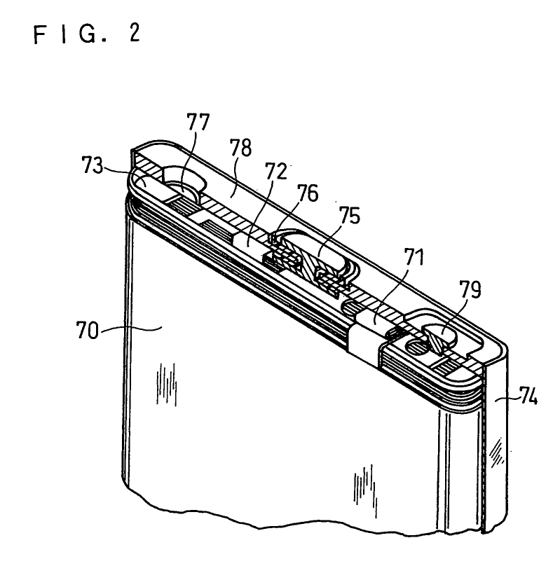

A prismatic non-aqueous electrolyte secondary battery as shown in FIG. 2 was assembled according to the following procedure to have a nominal capacity of 600 mA.

The positive and negative electrodes produced above were spirally wound with a 25-μm-thick microporous separator made of polyethylene resin interposed therebetween to give an electrode group 70. The ends of a positive electrode lead 71 made of aluminum and a negative electrode lead 72 made of nickel were welded to the positive and negative electrodes, respectively. On the top of the electrode group was provided an insulating plate 73 made of polyethylene resin, and the electrode group was then housed in a battery case 74. The other end of the positive electrode lead was spot-welded to the underside of a sealing plate 78 having an appropriate safety valve 77. The other end of the negative electrode lead was electrically connected to the underside of a negative electrode terminal 75 made of nickel inserted into a terminal hole located in the center of the sealing plate with an insulating material 76 surrounding the negative electrode terminal 75.

The opening end of the battery case and the periphery of the sealing plate were laser welded. Then, a predetermined amount of non-aqueous electrolyte was fed from an inlet provided in the sealing plate. Finally, a sealing stopper 79 made of aluminum was placed on the inlet, which was then laser welded to hermetically seal the inlet. Thus, a battery was completed.

The non-aqueous electrolyte was prepared by dissolving LiPF₆ in a solvent mixture comprising ethylene carbonate (EC) and ethylmethyl carbonate (EMC) at a volume ratio of 1:3 at a LiPF₆ concentration of 1 mol/L.

### EXAMPLES 2 to 8

Positive electrodes were produced in the same manner as in Example 1, except that the content of the carbon nanotubes contained in the masterbatch and the amount of the carbon nanotubes or the masterbatch per 100 parts by weight of the positive electrode active material contained in the positive electrode material mixture paste were changed as shown in Table 1. In Examples 2 and 3, however, 0.5 parts by weight of particulate rubber (trade name: BM500B manufactured by Zeon Corporation) were further added to the positive electrode material mixture. With the use of the thus obtained positive electrodes, prismatic non-aqueous electrolyte secondary batteries analogous to the one in Example 1 were assembled.

TABLE 1

| | Amount of CNT | Amount of MB per | |
|---|---|---|---|
| | Per 100 parts by | 100 parts by | |
| | weight of active | weight of active | |
| | material | material | CNT content |
| | (parts by weight) | (parts by weight) | in MB (wt %) |
| Ex. 1 | 0.5 | 3.3 | 15 |
| Ex. 2 | 0.2 | 1.3 | 15 |
| Ex. 3 | 0.3 | 2 | 15 |
| Ex. 4 | 0.8 | 5.3 | 15 |
| Ex. 5 | 1.0 | 6.7 | 15 |
| Ex. 6 | 1.5 | 7.5 | 20 |
| Ex. 7 | 2.0 | 10 | 20 |
| Ex. 8 | 3.0 | 15 | 20 |

CNT: Carbon nanotube
MB: Masterbatch

### EXAMPLE 9

A positive electrode was produced in the same manner as in Example 1, except that a vinylidene fluoride-hexafluoropropylene copolymer was used as a resin used for the masterbatch instead of polyvinylidene fluoride. With the use of the thus obtained positive electrode, a prismatic non-aqueous electrolyte secondary battery analogous to the one in Example 1 was assembled.

### Examples 10 to 14

Positive electrodes were produced in the same manner as in Example 1, except that carbon nanotubes having an average diameter and an aspect ratio shown in Table 2 were used. With the use of the thus-obtained positive electrodes, prismatic non-aqueous electrolyte secondary batteries analogous to the one in Example 1 were assembled. Similar to Example 1, the average diameter and the aspect ratio were determined from the actual values obtained by observing 100 carbon nanotubes.

TABLE 2

| | Diameter of CNT | |
|---|---|---|
| | (μm) | Aspect Ratio |
| Ex. 10 | 0.01 | 1000 |
| Ex. 11 | 0.05 | 200 |
| Ex. 12 | 0.05 | 50 |
| Ex. 13 | 0.1 | 100 |
| Ex. 14 | 0.1 | 50 |

CNT: Carbon nanotube

### EXAMPLE 15

(i) Production of Positive Electrode

A positive electrode material mixture paste was produced by mixing 100 parts by weight of lithium cobalt oxide (LiCoO₂) as an active material, 3 parts by weight of acetylene black as a conductive material, 4 parts by weight of polyvinylidene fluoride as a binder and 45 parts by weight of N-methyl-2-pyrrolidone with a mixer. This positive electrode material mixture paste was applied onto both faces of a 20-μm-thick substrate made of aluminum foil, which was then dried and rolled. The electrode plate thus obtained was cut into a predetermined shape to give a positive electrode.

(ii) Production of Negative Electrode

A negative electrode material mixture paste was produced by mixing 3.3 parts by weight of masterbatch, the same as the one used in the production of the positive electrode in Example 1, 100 parts by weight of flake graphite as an active material and 56 parts by weight of N-methyl-2-pyrrolidone as a dispersion medium with a mixer. This negative electrode material mixture paste was applied on both faces of a 10-mm-thick substrate made of copper foil, which was then dried and rolled. The electrode plate thus produced was cut into a predetermined shape to give a negative electrode.

With the use of the positive and negative electrodes thus obtained, a prismatic non-aqueous electrolyte secondary battery analogous to the one in Example 1 was assembled.

### COMPARATIVE EXAMPLE 1

With the use of a positive electrode analogous to the one in Example 15 and a negative electrode analogous to the one in Example 1, a prismatic non-aqueous electrolyte secondary battery analogous to the one in Example 1 was assembled. In other words, both the positive and negative electrodes of the battery of this example did not contain the masterbatch.

[Evaluation]

<Battery Capacity>

Each battery was constantly charged to 4.2 V at a charge current of 600 mA at an ambient temperature of 20° C. After the battery voltage reached 4.2 V, the battery was charged at a constant voltage for 2 hours. The battery was then discharged at a discharge current of 120 mA with an end-of discharge voltage of 3.0 V, and the discharge capacity was measured. The results are shown in Table 3.

<Cycle Life>

Each battery was put through repeated charge and discharge cycles at an ambient temperature of 20° C.

In the charge and discharge cycles, charging was performed at a constant current with a maximum current value of 600 mA and an end-of-charge voltage of 4.2 V. After the battery voltage reached 4.2 V, a constant voltage charge was performed for 2 hours. Discharging was performed at a constant current with a current value of 600 mA and an end-of-discharge voltage of 3.0 V. Then, the ratio of the discharge capacity after 100 cycles to that after the first cycle was determined in percentage (%) as the capacity retention rate. The results are shown in Table 3.

TABLE 3

| | | Capacity Retention |
|---|---|---|
| | Battery Capacity (mAh) | Rate (%) |
| Ex. 1 | 645 | 70 |
| Ex. 2 | 660 | 63 |
| Ex. 3 | 650 | 67 |
| Ex. 4 | 620 | 71 |
| Ex. 5 | 610 | 72 |
| Ex. 6 | 600 | 76 |
| Ex. 7 | 590 | 79 |
| Ex. 8 | 540 | 79 |
| Ex. 9 | 642 | 69 |
| Ex. 10 | 626 | 70 |
| Ex. 11 | 630 | 72 |
| Ex. 12 | 641 | 67 |
| Ex. 13 | 643 | 69 |
| Ex. 14 | 635 | 66 |
| Ex. 15 | 650 | 71 |
| Comp. Ex. 1 | 580 | 50 |

<High Rate Discharge Characteristics>

The rate characteristics of the batteries of Example 15 and Comparative Example 1 were compared.

Each battery was constantly charged to 4.2 V at a charge current of 600 mA at an ambient temperature of 20° C. After the battery voltage reached 4.2 V, the battery was charged at a constant voltage for 2 hours. The battery was then discharged at a discharge current of 120 mA (0.2 C) with an end-of-discharge voltage of 3.0 V, and the discharge capacity was measured.

Subsequently, the each battery was constantly charged to 4.2 V at a charge current of 600 mA at an ambient temperature of 20° C. After the battery voltage reached 4.2 V, the battery was charged at a constant voltage for 2 hours. The battery was then discharged at a discharge current of 1200 mA (2 C) with an end-of-discharge voltage of 3.0 V, and the discharge capacity was measured.

The ratio of the discharge capacity obtained when discharged at 2 C to that obtained when discharged at 0.2 C (2 C/0.2 C ratio) was determined. The 2 C/0.2 C ratios obtained from the batteries of Example 15 and Comparative Example 1 were compared, and it was found that the 2 C/0.2 C ratio of the battery of Example 15 was increased by 10%, compared to that of the battery of Comparative Example 1.

As described above, according to the present invention, the use of a masterbatch process can reduce the amount of conductive material in an electrode, resulting in a greatly improved electrode capacity. In addition, since carbon nanotubes are used as a conductive material, the conductive paths are not damaged by shearing force, which is applied during the production of the masterbatch.

Furthermore, the use of carbon nanotubes as a conductive material improves the strength of an electrode plate, providing a secondary battery with an improved cycle life.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A method for producing an electrode for a battery comprising the steps of:
(a) producing a masterbatch comprising at least carbon nanotubes and a resin;
(b) blending an electrode material mixture containing at least said masterbatch and an electrode active material with a dispersion medium to prepare an electrode material mixture paste;
(c) applying said electrode material mixture paste onto an electrode substrate and then drying and rolling said electrode material mixture paste coated on said electrode substrate to obtain an electrode plate; and
(d) cutting said electrode plate to obtain an electrode with a predetermined shape.

2. The method for producing an electrode for a battery in accordance with claim 1, wherein said carbon nanotubes have an average diameter of not greater than 0.1 μm and an aspect ratio of not less than 100 determined by dividing the average length of said carbon nanotubes by said average diameter.

3. The method for producing an electrode for a battery in accordance with claim 1, wherein the amount of said carbon nanotubes contained in said masterbatch is 5 to 20 parts by weight per 100 parts by weight of said resin.

4. The method for producing an electrode for a battery in accordance with claim 1, wherein said electrode active material is a positive electrode active material, said substrate comprises aluminum or an aluminum alloy, and the amount of said carbon nanotubes contained in said electrode material mixture is 0.2 to 3 parts by weight per 100 parts by weight of said electrode active material.

5. The method for producing an electrode for a battery in accordance with claim 1, wherein said electrode active material is a negative electrode active material, said substrate comprises copper, a copper alloy, nickel, a nickel alloy, iron or an iron alloy; and the amount of said carbon nanotubes contained in said electrode material mixture is 0.2 to 3 parts by weight per 100 parts by weight of said electrode active material.

6. The method for producing an electrode for a battery in accordance with claim 1, wherein said resin comprises a fluorocarbon resin.

7. The method for producing an electrode for a battery in accordance with claim 6, wherein said fluorocarbon resin is at least one selected from the group consisting of polyvinylidene fluoride and a vinylidene fluoride-hexafluoropropylene copolymer.

8. The method for producing an electrode for a battery in accordance with claim 1, wherein in said step (b), in addition to said masterbatch and said electrode active material, said resin and/or a second resin are/is blended with said dispersion medium.

9. A positive electrode comprising a positive electrode active material, a resin and carbon nanotubes, wherein said carbon nanotubes have an average diameter of not greater than 0.1 μm and an aspect ratio of not less than 100 determined by dividing the average length of said carbon nanotubes by said average diameter, and the amount of said carbon nanotubes is 0.2 to 3 parts by weight per 100 parts by weight of said positive electrode active material.

10. A negative electrode comprising a negative electrode active material, a resin and carbon nanotubes, wherein said carbon nanotubes have an average diameter of not greater than 0.1 μm and an aspect ratio of not less than 100 determined by dividing the average length of said carbon nanotubes by said average diameter, and the amount of said carbon nanotubes is 0.2 to 3 parts by weight per 100 parts by weight of said negative electrode active material.
